(19) United States
(12) Patent Application Publication
(10) Pub. No.: US 2009/0178263 A1
(43) Pub. Date: Jul. 16, 2009

(54) Hinge Pin Removal and Attachment Tool

(76) Inventors: Theunis C. Robberts, Crookston, MN (US); Anthony E. Decembrini, Newport, OR (US)

Correspondence Address: NEUSTEL LAW OFFICES, LTD., 2534 SOUTH UNIVERSITY DRIVE, SUITE 4, FARGO, ND, 58103, US

(21) Appl. No.: 12/013,164

(22) Filed: Jan. 11, 2008

(51) Int. Cl. B25B 27/04

(52) U.S. Cl. 29/275

(57) ABSTRACT

A hinge pin removal and attachment tool for efficiently and easily removing a hinge pin from a hinge. The hinge pin removal and attachment tool generally includes a support including a pounding portion and a handle portion, wherein the pounding portion extends from the handle portion and wherein the pounding portion includes a planar outer surface. A driving member extends from the pounding portion of the support opposite the planar surface, wherein the driving member includes a substantially uniform diameter to extend within a passageway of a hinge.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an apparatus to remove hinge pins and more specifically it relates to a hinge pin removal and attachment tool for efficiently and easily removing a hinge pin from a hinge.

2. Description of the Related Art

Any discussion of the related art throughout the specification should in no way be considered as an admission that such related art is widely known or forms part of common general knowledge in the field.

Hinges have been in use for years. Typically, hinges are manufactured in various sizes and configurations to attach various size movable objects (e.g. door, cabinet, etc.) to another supporting object (e.g. wall, etc.). Hinges generally include a pair of outer plates each including an interlocking knuckle, wherein a pin extends through a passageway formed by the interlocking knuckle of each of the plates to connect the plates. The plates are then able to pivot about one another, wherein each plate is attached to either the supporting object or the movable object.

At times it may be necessary to temporarily remove the movable object from the supporting object, such as when painting, refinishing, fixing the objects. To remove the movable object, rather than removing the entire hinge, the pin may be removed from between the two plates thus releasing the two plates from one another. To remove the pin, a punch or other elongated object is generally abutted to an end of the pin and the punch is pounded upon thus forcing the pin out of the interlocking knuckle.

It may be difficult to pound upon the punch or the pin without scraping or damaging the outer surface of the movable object (e.g. door, etc.) or support object (e.g. wall, etc.) because the hinge and pin are often positioned substantially close to the outer surface of the attached objects. Because of the inherent problems with the related art, there is a need for a new and improved hinge pin removal and attachment tool for efficiently and easily removing a hinge pin from a hinge.

### BRIEF SUMMARY OF THE INVENTION

The general purpose of the present invention is to provide a hinge pin removal and attachment tool that has many of the advantages of the manners in which to remove hinge pins mentioned heretofore. The invention generally relates to a hinge pin removal and attachment tool which includes a support including a pounding portion and a handle portion, wherein the pounding portion extends from the handle portion and wherein the pounding portion includes a planar outer surface. A driving member extends from the pounding portion of the support opposite the planar surface, wherein the driving member includes a substantially uniform diameter to extend within a passageway of a hinge.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a hinge pin removal and attachment tool for efficiently and easily removing a hinge pin from a hinge.

Another object is to provide a hinge pin removal and attachment tool that is easy to utilize.

An additional object is to provide a hinge pin removal and attachment tool that prevents a user from damaging an adjacent door, wall or other object when removing the pin of the hinge.

A further object is to provide a hinge pin removal and attachment tool that may be efficiently stabilized by an operator during use so as to allow the operator to properly align the present invention with the pin of the hinge.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention including the protective member.

FIG. 3 is an upper perspective view of the present invention including the protective member.

FIG. 4 is an upper perspective view of the present invention in use while removing a pin from a hinge with the driving member.

FIG. 5 is an upper perspective view of the present invention in use while removing a pin from a hinge with the tapered portion of the support.

FIG. 6 is an upper perspective view of the present invention in use while positioning a pin within the hinge.

FIG. 7 is a top view of the present invention.

FIG. 8 is a bottom view of the present invention.

FIG. 9 is a side view of the present invention.

FIG. 10 is a longitudinal cross-sectional view of the present invention including the protective member, wherein the driving member is extending partially within the passageway of the hinge.

FIG. 11 is a longitudinal cross-sectional view of the driving member threadably attached to the support.

FIG. 12 is a side view of the driving member hingedbly attached to the support.

### DETAILED DESCRIPTION OF THE INVENTION

### A. Overview

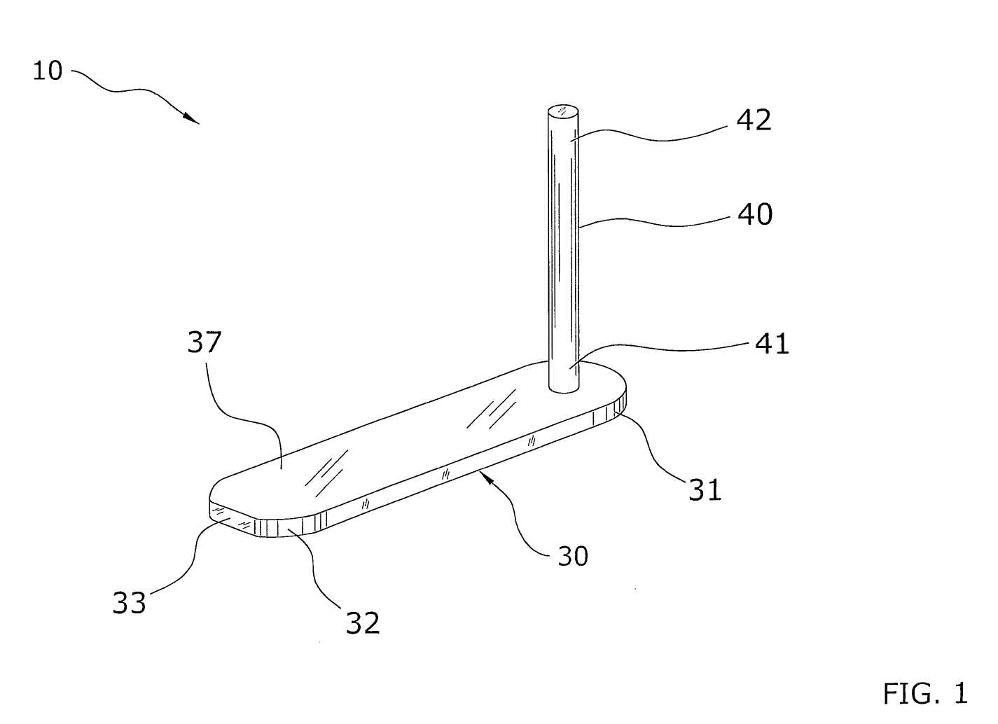

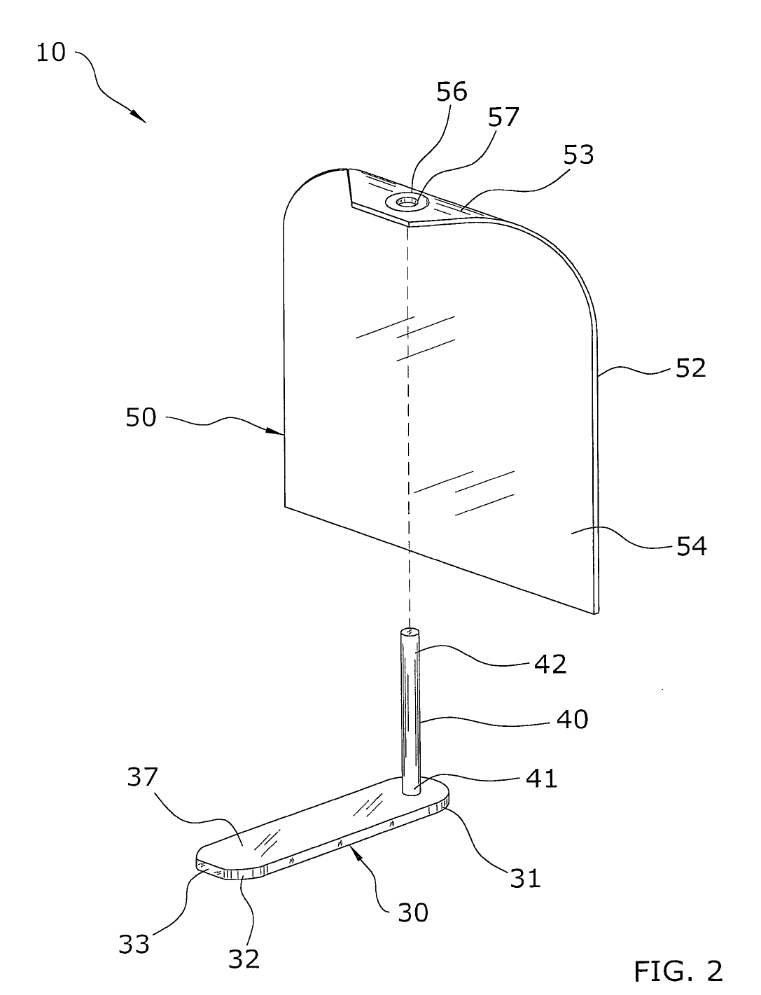

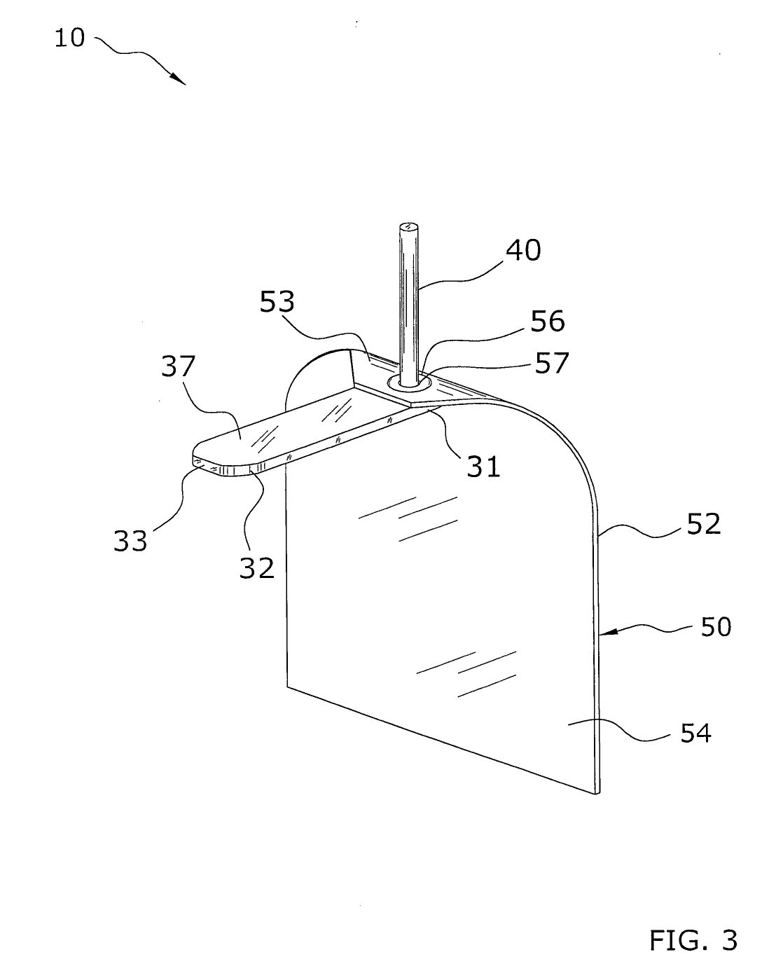

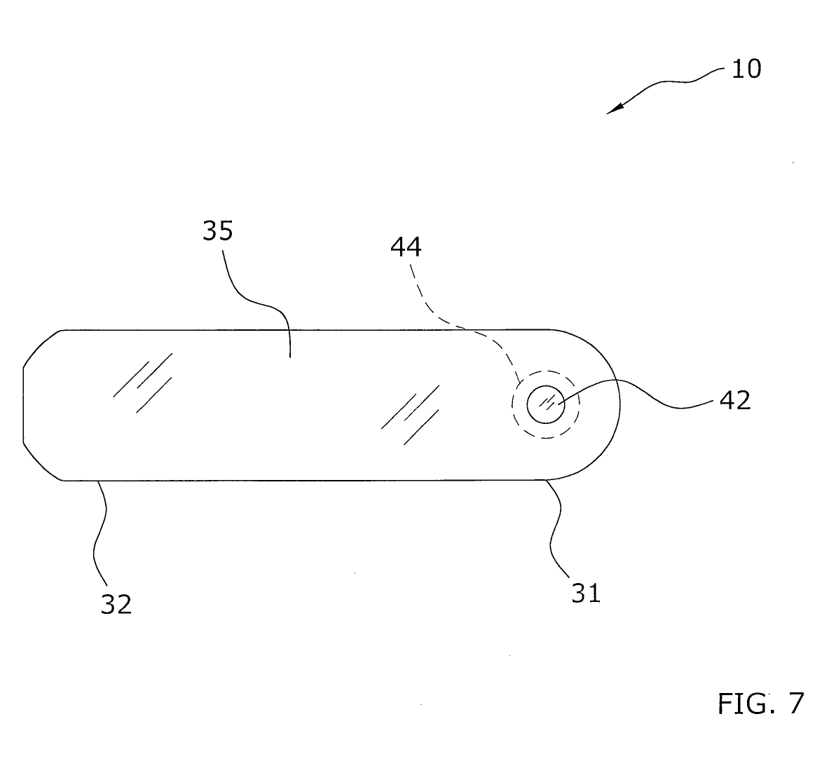

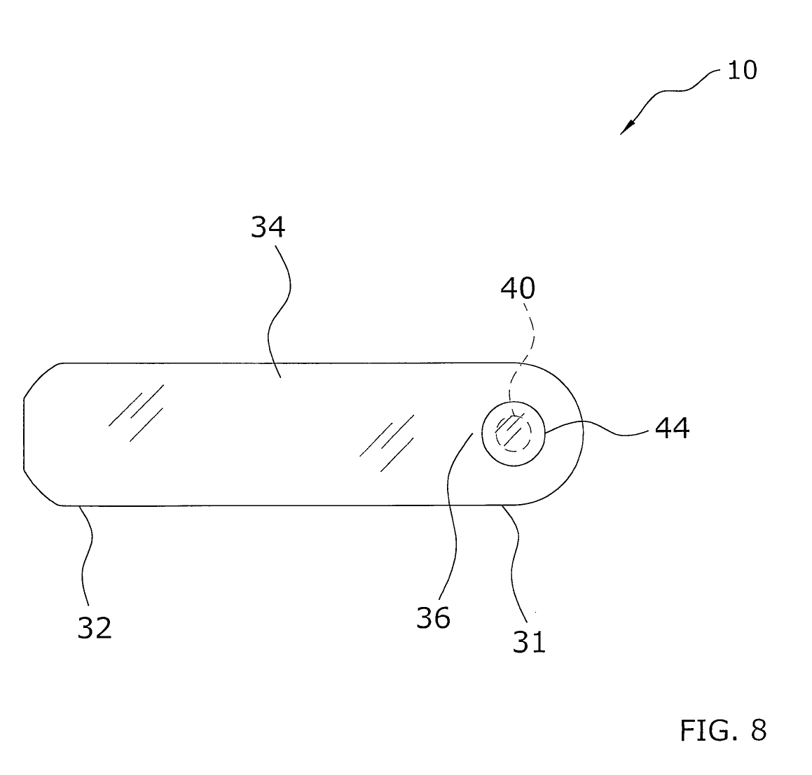

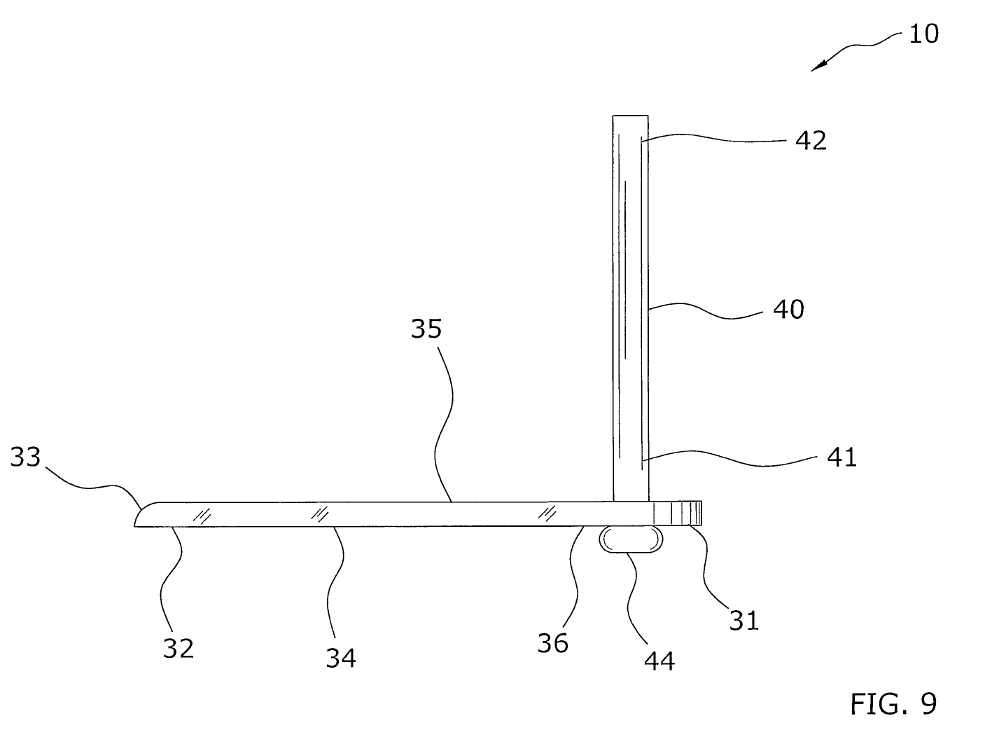

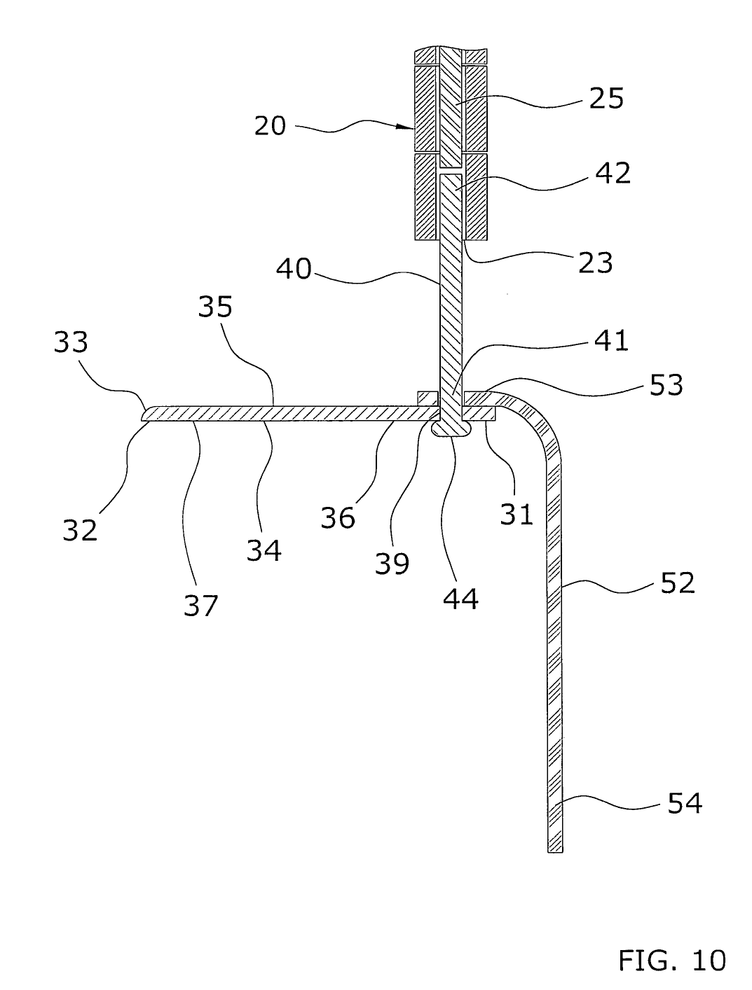

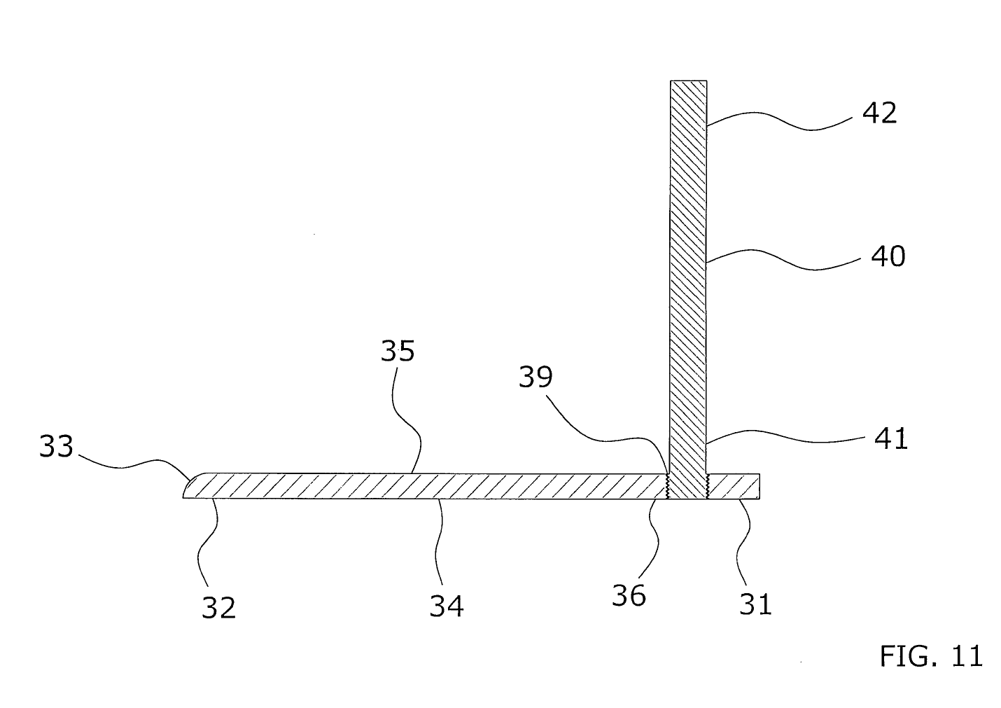

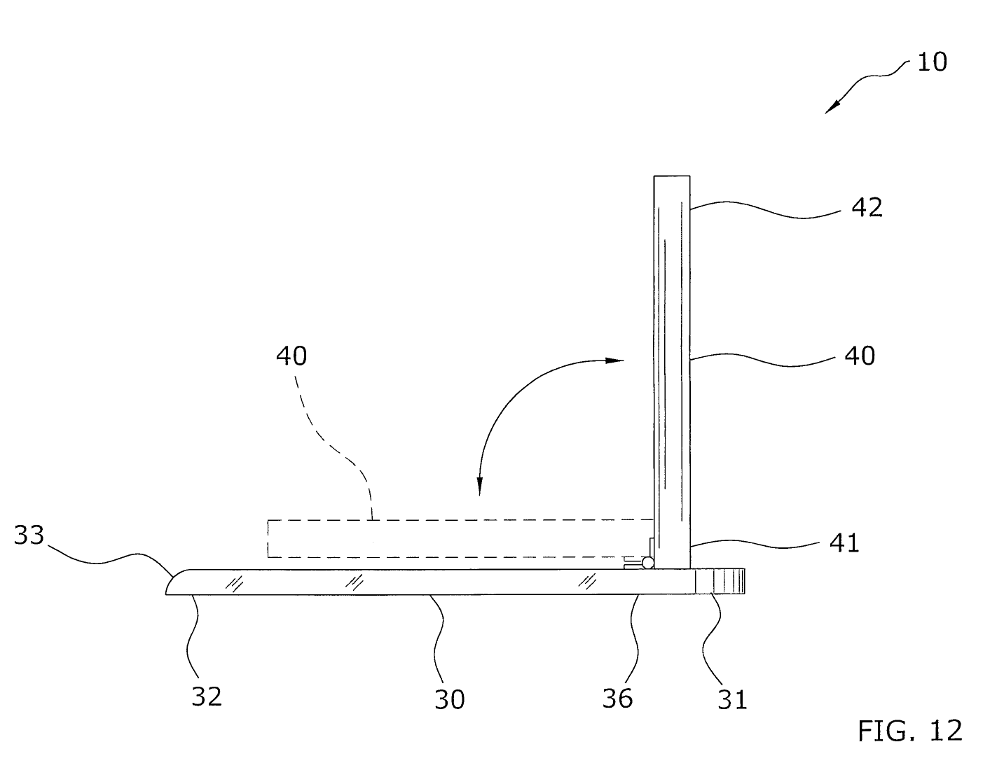

Turning now descriptively to the drawings, in which similar reference characters denote similar elements throughout the several views, FIGS. 1 through 12 illustrate a hinge pin removal and attachment tool 10, which comprises a support 30 including a pounding portion 36 and a handle portion 37, wherein the pounding portion 36 extends from the handle portion 37 and wherein the pounding portion 36 includes a planar outer surface 34. A driving member 40 extends from the pounding portion 36 of the support 30 opposite the planar surface 34, wherein the driving member 40 includes a substantially uniform diameter to extend within a passageway 23 of a hinge 20.

### B. Support

The support 30 is utilized to stabilize the driving member 40, provide a place in which to pound upon the driving member 40 or transfer a force to the driving member 40 and also as a handle. The support 30 is preferably comprised of a substantially strong material (e.g. metal, hardened steel, etc.) to withstand various blows as from a hammer 16 or other pounding tool (e.g. force from a pneumatic system, hydraulic system, electrical system, etc.) and also to be able to transfer a pounding force from the pounding tool 16.

The support 30 is preferably comprised of an elongated configuration so as to allow a user to both position a first end 31 substantially concentric with a pin 25 of a hinge 20 and also to hold a second end 32 (i.e. opposing end) of the support 30. The first end 31 may be comprised of various configurations all which allow the first end 31 of the support 30 to be positioned substantially close to the hinge 20. In the preferred embodiment the first end 31 is comprised of a semi-circular shaped configuration. The support 30 is preferably comprised of a plate configuration. The support 30 is further preferably comprised of a straight configuration.

The second end 32 may also be comprised of various configurations all which allow an operator to efficiently grasp the second end 32. In the preferred embodiment the second end 32 is comprised of a tapered or angled configuration. The second end 32 preferably tapers inwardly toward the second end 32 and also preferably tapers inwardly toward the inner surface 35 from the outer surface 34.

It is appreciated that the tapered portion 33 of the second end 32 may be utilized to initially pry the head 27 of the pin 25 away from knuckles 22 of the hinge 20. The second end 32 may also be angularly positioned between the head 27 and the pin 25 and the shaft 26 of the pin 25 and the first end 31 pounded upon to further remove the pin 25 from the passageway 23. The inner surface 35 is further preferably parallel to the outer surface 34.

The outer surface 34 of the support 30 is preferably comprised of a planar configuration, wherein it is especially important that the pounding portion 36 of the support 30 be comprised of a planar configuration to allow the operator or automated device to efficiently pound upon or apply a force to the pounding portion 36. In the preferred embodiment, the inner surface 35 is also comprised of a planar configuration which may allow a user to more efficiently grasp the support 30 and also allow the support 30 to be positioned as close as possible to the knuckles 22 and thus passageway 23 of the hinge 20. It is appreciated though that the inner surface 35 may be comprised of various shapes and configurations. The outer surface 34 of the support 30 and the outer surface of the pounding portion 36 are preferably comprised of a similar surface.

The pounding portion 36 is preferably positioned substantially close to the second end 32 to be able to transfer a more direct force from the support 30, to the driving member 40 to the pin 25. The pounding portion 36 is preferably integral with the outer surface 34 of the support 30. The pounding portion 36 also preferably includes a greater surface area than that of the end of the pin 25 to allow a more easily hittable and poundable surface to pound upon.

An opening 39 may also extend through the pounding portion 36. The opening 39 is preferably centered upon the pounding portion 36. The opening 39 receives the driving member 40. It is appreciated that the driving member 40 may be integrally formed with the support 30 and thus alleviating the need for the opening 39. A handle portion 37 is preferably opposite the pounding portion 36 and is further preferably integrally formed with the support 30 and the pounding portion 36. The handle portion 37 may be comprised of various shapes all which allow the operator to easily grasp the handle portion 37.

### C. Driving Member

The driving member 40 is utilized to push and transfer a force to the pin 25 of the hinge 20. The driving member 40 is preferably comprised of a substantially strong material (e.g. metal, hardened steel, etc.) to withstand various blows as from a hammer 16 or other pounding tool (e.g. force from a pneumatic system, hydraulic system, electrical system, etc.) and also to be able to transfer a pounding force from the pounding tool 16 to the pin 25. The driving member 40 is also preferably perpendicular to the support 30 and pounding portion 36 of the support 30. It is appreciated that the driving member 40 may also be hingedbly attached with respect to the support 30, threadably attached to the support 30 or attached in various other manners to the support 30.

The driving member 40 preferably includes a uniform diameter extending from an outer end 42 of the driving member 40 to an inner end 41 of the driving member 40 to allow the driving member 40 to fully extend within the passageway 23 formed within the knuckles 22 of the hinge 20. The diameter of the driving member 40 is thus substantially similar or slightly less than the diameter of the passageway 23. The driving member 40 is preferably comprised of a cylindrical shaped configuration; however it is appreciated that the driving member 40 may be comprised of various shapes rather than the preferred embodiment all which are able to extend within the passageway 23.

The driving member 40 is also comprised of an elongated configuration to extend a sufficient distance within the passageway 23 of the pin 25. The sufficient distance is preferably close to or over a longitudinal length of the passageway 23, wherein the operator is able to easily remove the pin 25 from the passageway 23 of the hinge 20 thereafter.

The inner end 41 of the driving member 40 preferably extends through the opening 39, wherein the inner end 41 may be simply positioned within the opening 39 or the inner end 41 may be fixedly attached (e.g. weldebly, etc.) within the opening 39. The driving member 40 also preferably includes a stopper portion 44 extending from the inner end 41 and positioned upon the same side as the outer surface 34 of the support 30 to prevent the driving member 40 from sliding forwardly out of the opening 39.

The stopper portion 44 is especially important if the inner end 41 is not fixedly attached within the opening 39. A diameter of the stopper portion 44 is also greater than the diameter of the opening 39. It is appreciated that the operator may pound upon the stopper portion 44 with the pounding tool 16 rather than the pounding portion 36 of the support 30 if the stopper portion 44 extends beyond the outer surface 34 and thus pounding portion 36 of the support 30.

### D. Protective Member

The present invention may also include a protective member 50 to prevent the operator from engaging the door 12, wall 13, door trim or other surrounding object with the side of the pounding tool 16 (e.g. hammer, etc.) while pounding upon the present invention by forming a barrier (i.e. by concealing, etc.) between thereof. The protective member 50 extends from the driving member 40 or support 30 opposite the handle portion 37 of the support 30.

The protective member 50 is preferably comprised of a shroud 52. The shroud 52 is preferably comprised of a flexible configuration. The shroud 52 may be comprised of various durable configurations (e.g. canvas, rubber, leather, polymer, polymer blend, organic, organic polymer blend, Teflon®, etc.) to not rip if engaged between the pounding tool and door 12 or wall 13. It is appreciated that the shroud 52 may be comprised of a preformed rigid configuration and material (e.g. plastic, etc.).

The shroud 52 (i.e. flap, etc.) includes a connecting portion 53, wherein the connecting portion 53 connects to the driving member 40 adjacent the support 30 or may also connect to the support 30. A grommet 56 preferably extends through the connecting portion 53 and further preferably extends through a center of the connecting portion 53 so the shroud 52 extends evenly across the driving member 40 upon both sides. The grommet 56 includes an aperture 57, wherein the aperture 57 is preferably received by the outer end 42 of the driving member 40 and slid towards the support 30. It is appreciated that the protective member 50 may be slid on and off the driving member 40 as desired.

A protecting portion 54 also extends from the protective member 50 and preferably hangs down from the connecting portion 53 during use. The protecting portion 54 is ensured to be positioned between the pounding tool and the door 12, wall 13 or other object adjacent the hinge 20 during use. The protecting portion 54 may be comprised of various lengths (e.g. 5 inches, etc.). The protecting portion 54 and the connecting portion 53 are further preferably comprised of an integrally formed structure.

### E. Operation of Preferred Embodiment

In use, to remove the pin 25 from the hinge 20, the outer end 42 of the driving member 40 is concentrically aligned with the shaft 26 of the pin 25 (opposite the head 27 of the pin 25). The protective member 50 may also be utilized at this time by extending the driving member 40 through the grommet 56 and positioning the grommet 56 adjacent the support 30 and the shroud 52 between the pounding area (i.e. area where the pounding tool 16 is swung or moves within to engage the present invention).

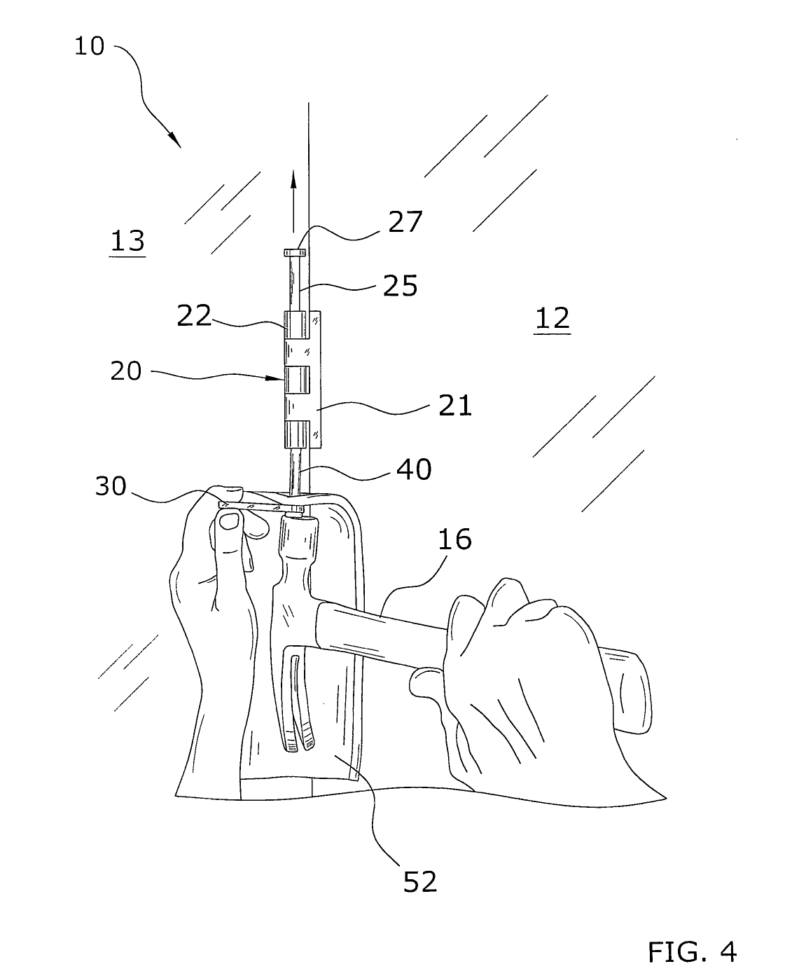

The operator now firmly grasps the handle portion 37 of the support 30 and engages the pounding portion 36 of the support 30 with the pounding tool 16 thus driving the pin 25 out of the opposing end of the passageway 23 as illustrated in FIG. 4. The operator continues to engage the pounding portion 36 to transfer and outward force from the present invention to the pin 25 until the support 30 is positioned against the hinge 20 and the driving member 40 is extended fully within the passageway 23.

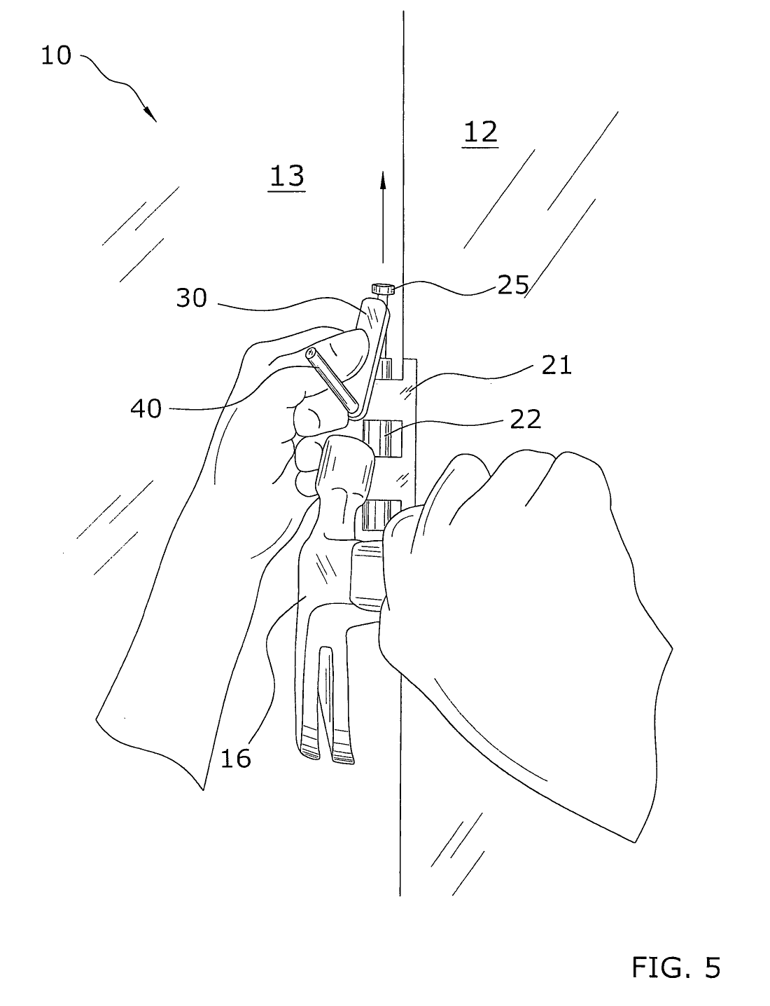

The operator may now drive the remaining portion of the pin 25 within the passageway 23 out of the passageway 23 by angularly positioning the tapered portion 33 of the second end 32 between the head 27 and the shaft 26 of the pin 25 as illustrated in FIG. 5. The operator now applies a force (i.e. via pounding with the pounding tool 16, etc.) to the first end 31 of the support 30 until the pin 25 is completely removed from the passageway 23 and the plates 21 of the hinge 20 may be separated. It is appreciated that the protective member 50 may be removed at this time if the protective member 50 is in the way of the operator pounding upon the first end 31 of the support 30.

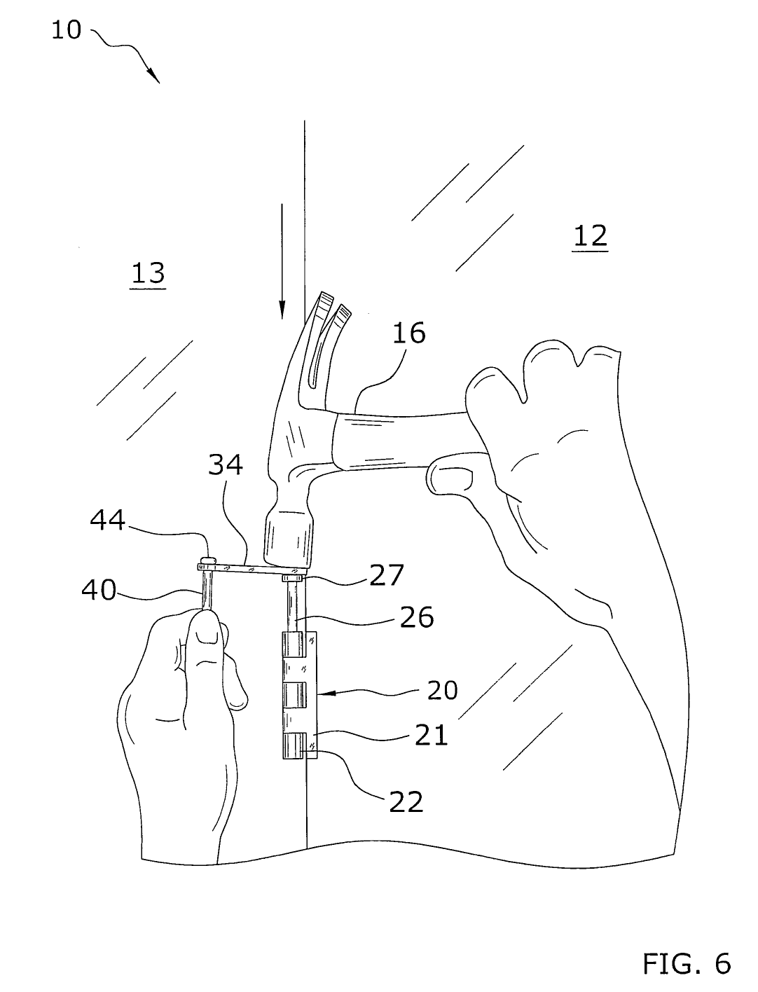

To replace the pin 25 back within the passageway 23 of the hinge 20, the knuckles 22 of hinge 20 are first aligned to form the passageway 23. The shaft 26 of the pin 25 is now extended within the passageway 23 until the pin 25 may no longer be manually forced within the passageway 23. The operator now concentrically aligns the inner surface 35 of the handle portion 37 of the support 30 with the head 27 of the pin 25 and applies a force (i.e. via pounding with the pounding tool 16, etc.) upon the outer surface 34 of the handle portion 37 of the support 30 towards the hinge 20 as illustrated in FIG. 6. The operator continues to apply the force until the pin 25 is fully extended within the passageway 23.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A hinge pin removal and attachment tool, comprising:
a support including a pounding portion and a handle portion, wherein said pounding portion extends from said handle portion;
wherein said pounding portion includes a planar outer surface; and
a driving member extending from said pounding portion opposite said planar surface;
wherein said driving member includes a substantially uniform diameter to extend within a passageway of a hinge.

2. The hinge pin removal and attachment tool of claim 1, wherein a support outer surface and a support inner surface of said support are comprised of a planar configuration.

3. The hinge pin removal and attachment tool of claim 2, wherein said support outer surface is parallel to said support inner surface.

4. The hinge pin removal and attachment tool of claim 1, wherein said support is comprised of a straight configuration.

5. The hinge pin removal and attachment tool of claim 1, wherein said support includes a tapered portion.

6. The hinge pin removal and attachment tool of claim 1, wherein said driving member includes a stopper portion positioned on a similar side as said planar outer surface of said pounding portion and wherein a diameter of said stopper portion is greater than said uniform diameter of said driving member.

7. The hinge pin removal and attachment tool of claim 1, including a protective member extending from said driving member.

8. The hinge pin removal and attachment tool of claim 7, wherein said protective member is comprised of a flexible configuration.

9. The hinge pin removal and attachment tool of claim 7, wherein said protective member removably attaches to said driving member.

10. The hinge pin removal and attachment tool of claim 1, wherein said driving member is comprised of a cylindrical shaped configuration.

11. The hinge pin removal and attachment tool of claim 1, wherein said hinge is comprised of a door hinge.

12. (canceled)

13. (canceled)

14. A hinge pin removal and attachment tool, comprising:
a support including a pounding portion and a handle portion, wherein said pounding portion extends from said handle portion;
wherein said pounding portion includes a planar outer surface;
a driving member extending from said pounding portion opposite said planar surface;
wherein said driving member includes a substantially uniform diameter to extend within a passageway of a hinge; and
a protective member suspended from said driving member opposite said handle portion.

15. The hinge pin removal and attachment tool of claim 14, wherein said support outer surface is parallel to said support inner surface.

16. The hinge pin removal and attachment tool of claim 14, wherein said support is comprised of a straight configuration.

17. The hinge pin removal and attachment tool of claim 14, wherein said support includes a tapered portion.

18. The hinge pin removal and attachment tool of claim 14, wherein said driving member includes a stopper portion positioned on a similar side as said planar outer surface of said pounding portion and wherein a diameter of said stopper portion is greater than said uniform diameter of said driving member.

19. The hinge pin removal and attachment tool of claim 14, wherein said protective member is comprised of a flexible configuration.

20. A hinge pin removal and attachment tool, comprising:
a support including a pounding portion and a handle portion, wherein said pounding portion extends from said handle portion;
wherein said pounding portion includes a planar outer surface;
a driving member extending from said pounding portion opposite said planar surface;
wherein said driving member includes a substantially uniform diameter to extend within a passageway of a hinge;
wherein a support outer surface and a support inner surface of said support are comprised of a planar configuration;
wherein said support outer surface is parallel to said support inner surface;
wherein said support is comprised of a straight configuration;
wherein said support includes a tapered portion;
wherein said driving member includes a stopper portion positioned on a similar side as said planar outer surface of said pounding portion;
wherein a diameter of said stopper portion is greater than said uniform diameter of said driving member; and
a protective member extending from said driving member;
wherein said protective member is comprised of a shroud;
wherein said protective member removably attaches to said driving member;
wherein said driving member is comprised of a cylindrical shaped configuration;
wherein said hinge is comprised of a door hinge.
